(19) United States
(12) Patent Application Publication
(10) Pub. No.: US 2010/0017356 A1
(43) Pub. Date: Jan. 21, 2010

(54) Method for Identifying Protein Patterns in Mass Spectrometry

(76) Inventors: Wim Maurits Sylvain Degrave, Rio de Janeiro (BR); Paulo Costa Carvalho, Rio de Janeiro (BR); Maria da Gloria da Costa Carvalho, Rio de Janeiro (BR); Gilberto Barbosa Domont, Rio de Janeiro (BR); Raul Fonseca Neto, Minas Gerais (BR); Sergio Lilla, Sao Paulo (BR)

Correspondence Address: MEREK, BLACKMON & VOORHEES, LLC, 673 S. WASHINGTON ST., ALEXANDRIA, VA, 22314, US

(21) Appl. No.: 12/083,560

(22) PCT Filed: Oct. 16, 2006
(86) PCT No.: PCT/BR2006/000214

§ 371 Date: Sep. 11, 2009

(30) Foreign Application Priority Data
Oct. 14, 2005 (BR) PI 0506117-2

(51) Int. Cl. G06N 5/02

(52) U.S. Cl. 706/54

(57) ABSTRACT

The present invention refers to a medical diagnostic method based on proteomic and/or genomic patterns, using data obtained by mass spectrometry. The method also allows classifying the patients as to their disease stage Additionally, present invention also refers to two new biomarkers for the Hodgkin Disease medical diagnosis. Based on the SVM analysis, one localizes the windows of interest and later on uses the mass spectrum so to allow the biomarkers localization, so that the identification of said biomarkers occur by means of a 2D gel ou by mass spectrometry.

### FIELD OF INVENTION

The present invention refers to a medical diagnostic method based on proteomic and/or genomic patterns, using data obtained by mass spectrometry. The method also allows classifying the patients as to their disease stage.

When comparing different states (i.e. healthy, disease), it has been shown that certain protein expression levels can correlate with the disease stage. These protein patterns, or biomarkers, are a challenge to identify, since they are usually present in femtomolar ranges, and masked by the thousands of proteins present within complex biological samples. Mass spectrometry (MS) based proteomics currently drives biomarker discovery and has created great expectations for disease classification and prognosis. Most existing feature selection methods are able to rapidly obtain a good feature set for classification, however the optimal solution is not guaranteed to be found. In this invention we show how to cluster data and then detect putative biomarker pattern in MS, LC/MS/MS and LC/LC/MS/MS data. The biomarker pattern can aid in disease diagnosis and prognosis

Additionally, present invention also refers to two new biomarkers for medical diagnosis of the Hodgkin disease.

### BACKGROUND OF THE INVENTION

During the last 40 years, the quest for diagnosing pathologies during its initial stages by using biomarkers has constantly driven the medical field to test new heights. The search for a biomarker can take place by profiling a patient's proteome. Biomarker patterns can also reflect an individual's response to a treatment; however, a unique biomarker has failed to be specific for a single pathology until today, alas, requiring a panel to increase specificity. As example, it is worth noting the prostate-specific antigen (PSA), much used in the diagnosis of prostate cancer, but sometimes failing to correctly indicate the disease.

Proteome can be defined as the proteins expressed by a given genome, which can greatly vary over time, with the presence of a pathology or a drug treatment. Most of the proteome analyses disclosed for biomarkers make use of two dimensional gel electrophoresis (2DE). The former is carried out by contrasting biological samples from patients and control subjects, having protein profiles separated on a gel according to their pH and molecular mass. Eventhough this technique has contributed to the development of the genomic/proteomic segment, many limitations still prevail in the state-of-art. Among these limitations we cite the need of better methods to predict the codant capacity of a genome and that of the proteome, as to identify protein cellular localization, disease markers and drugs targets. The 2DE is not adequate to be used in medical routine, considering that it is laborious, time consuming, limited to discriminate protein profiles within a pH range that varies approximately between 3.5 to 11.5, and molecular weight varying approximately between 7 and 200 kDa. Moreover, even to trace the biomarkers, 2DE should be applied to a great number of samples, becoming expensive and inappropriate for this kind of research.

Many methods for biomarker hunting is described in the available literature. Some have been used to differentiate cancer from control samples by directly infusing biological samples in the mass spectrometry for proteomic profiling. These approaches aimed in selecting subsets of spectral peaks in MS of biological samples from different states (i.e. cancer patients and control subjects) enabling statistical models to “correctly” classify unknown spectra. The selected peaks having statistically different ion intensities among classes indicated the mass to charge ratio for putative biomarkers. For breast cancer, “unified maximum separability analysis” was employed; for prostate cancer, decision trees with boosting techniques and classical statistical methods were used. For ovarian cancer, two different algorithms were employed: the self-organizing map of Kohonen and a linear discriminant. The SELDI technique involves the analysis of small sets of proteins, pre-selected by their affinity properties with the SELDI plate. However, depletion of proteins could result in loss of potential biomarkers or changes in sera patterns.

Other methods for diagnosis have been described such as in U.S. Pat. No. 6,835,927 and U.S. Pat. No. 6,134,344. U.S. Pat. No. 6,835,927 describes a method to search for discriminatory patterns within mass spectrometry peaks by using principle component analysis, least minimum squares or even neural networks. Such methods perform inferior to SVMs when operating in a high dimensional feature space with scarce data since they are limited to minimizing the empirical risk of the dataset while SVMs minimize simultaneously the empirical risk and the generalization error. Furthermore, patent U.S. Pat. No. 6,835,927 does not clarify how to classify an individual if an unexpected protein expression profile is obtained. A classification methodology to treat mass spectral data should be very robust against overfitting since the complexity within protein profiles of biological samples is tremendous. Furthermore neither U.S. Pat. No. 6,835,927 or U.S. Pat. No. 6,134,344 show ways to take advantage of physicochemical properties that are contained within the mass spec data that can greatly be used to the advantage of the pattern recognition strategy. The other patent, U.S. Pat. No. 6,134,344 describes a method to increase the efficiency and speed of the analysis in a way to use a reduced number of entries. The elimination of data could also represent a loss in the generalization capacity of a learning machine or eliminate samples that are believed to be outliers but represent important subclasses within a pathology.

The Hodgkin's disease (HD) is here used as a model to exemplify the present achievement. HD is characterized by the presence of lymphoma. HD's clinical diagnosis comprehends various tests to identify type, disease stage and other information to subsidize in the medical decisions.

Before describing the inventions, we will carefully define the meaning of a few terms that we will extensively refer to along this work; they are: feature, feature space and patterns. We define features as individual measurable properties of the phenomena being observed. For this patent, the features will be composed information originating from the mass spectra data (i.e. clustered mass peaks, how many times a specific ion was detected, spectral counts). We define feature space as an abstract space where each pattern sample is represented as a point in this n-dimensional space whose dimension is determined by the number of features used to describe the patterns. The patterns are the combinations of features that, according to machine learning/classification technique, can better separate among predefined classes.

The pattern recognition method of this invention describes ways to cluster features before a feature selection method is applied. The referred clustering takes advantage of intrinsic data contained within the mass spectra to correctly group related features. This is superior to directly applying a feature selection method directly to the raw mass spectra data because the direct strategy would not take advantage of such “extra” information that is part of the nature of a mass spectrum. Such intrinsic information comprehends the isotopic distribution of carbon 13 in the biological samples, or even clustering features as to their ion fragmentation patterns achieved with tandem mass spectrometry. Such is the case of ion counting and spectral counting. We will demonstrate how to benefit from such information using examples described below.

After the feature clustering/pre-processing, feature selection strategies based on support vector machines (SVM) and the structural risk minimization are employed to search for biomarker patterns. Such methods also allow the classification of non-linearly separable data within the feature space.

SVM is described as a class of algorithms that makes use of kernels, has absence of local minimum, sparse solution, characterized by the use of support vectors and based on the structural risk minimization theory. In case of complex problems, competing strategies to SVM that show a high capacity of “adequacy” to the training data set could entail “vicious apprenticeship”, the so called overfitting, and would then be deprived from the generalization power. SVM excels previous methodologies because of its generalization capacity and examples can be easily found in several known fields, such as: image, text, handwriting, or even sound identification and problems that can hardly be mathematically modeled. Recently with SVMs applied to bioinformatics, it has bee possible to discriminate different stages of cancers within microarray data, identify the disease evolution stage, aid in the design of new drugs, and in discovering proteins functions, predict their shapes, sub cellular localization, protein-protein interactions and identify transmembrane proteins amongst others.

Among other advantages of this invention, it provides means to allow the assessment of the post-translatable modifications. This invention also shows how to cluster data by “windows of interest” that can group key extensions of a mass spectrum to then perform feature selection and localize the biomarkers. Their identification can then be carried out by 2D gel or tandem mass spectrometry.

### SUMMARY OF THE INVENTION

This invention presents a medical diagnostic method based on proteomic and/or genomic patterns using data obtained by mass spectrometry. The invention makes possible to classify a diseases' stage, or elucidate new biomarker panels. The method for discriminating the biomarker panel is based on a previous clustering of the features to reduce the cardinality of the feature space We refer to this preprocessing as a maximum divergence analysis (MDA) using SVM throughout the first set of examples. MDA “navigates” over the mass spectra data pool and by using the leave-one-out cross validation can spot possible sections within the mass spectrum data to search for biomarkers. After the clustering, feature selection methods (to be described) are used reduce the signal/noise in the diagnosis deciding process.

Therefore, the first objective of present invention is to make available a medical specialist system that, by performing a supervised learning in data obtained by mass spectrometry, permits the classification of patients as to their disease stage or by indicating if an unknown sample belongs to a patient or a control subject.

Additionally, the present invention also refers to the discovery of MS peak patterns that point to two new biomarkers that could aid in the diagnosis of the Hodgkin disease

### BRIEF DESCRIPTION OF THE FIGURES

FIG. 1 shows a line that represents the decision boundary between two classes of points.

FIG. 2 shows the MDA results for a navigation window opening of approximately 2240 and 4480 Da.

FIG. 3 Mass spectrum from a randomly chosen HD patient (3A) and average spectrum created in silico obtained from serum spectra data of all individual HD patients (3B). Mass spectrum from a randomly chosen control subject (3C) and average spectrum created in silico obtained from serum spectra data of all control subjects (3D) Note the differentially expressed peak of 132,740 Da.

FIG. 4 shows the MDA analysis for study windows of of approximately 20 m/z and 10 m/z. This spectrum section indicates the indicative site of potential biomarkers for clinical diagnosis.

FIG. 5 shows the mass spectrum for a section of the spectrum where one observes the presence of isotopic envelops differently expressed in approximately 980 and 994 m/z in serum samples of control patients.

FIG. 6. Demonstration of two methods for mapping mass spectra peaks to the feature space. Sections A and 6B show two simplified hypothetical mass spectra containing three peptides. The Y axis indicates MS signal intensity and the X axis the mass to charge ration of the ion (peptide). For the sake of simplicity, let all three peptide have a charge of +1, making the x axis represent mass. Each peptide appears as three consecutive peaks with a +1 Dalton shift in mass; characterizing an isotopic envelope.

On the top example, study windows are generated as to match the span of isotopic envelopes. A value for each study windows is addressed by integrating the MS signal within the window. Case A could be coded/clustered as an input vector according to the following example: 1:15 2:0 3:13 4:0 5:16 where the numbers before the “:” indicate a respective dimension in the feature space and the numbers following the “:”, hypothetically created, indicating the window value. The dimension for each feature could be assigned according to the initial X value comprehended within the window.

The lower mass spectrum indicates another method for safely compressing the mass spectra data to the input vector format. A heuristics is applied to identify the peaks belonging to an isotopic distribution. Then an input vector is coded according to the example: 1:15 2:13 3:16 having thee dimension value assigned according to the mass of the monoisotopic peak for each feature.

It should be noted that both methods show ways to compress thousands of peaks contained within the mass spectra to features that correctly represent the corresponding peptides, however in a lower dimensional feature space to avoid overfitting, so feature selection can be applied.

FIG. 7: Sum of Pscores calculated for each combination of normalization/feature selection method when comparing the different spiked concentrations (legend), with (2B) and without (2A) log preprocessing. Lower bars indicate better performance. If a method performed poorly for a given concentration, the maximum penalty was limited to one, thus the worst total score a method can obtain is 3. We recall that the Pscore is calculated by obtaining the Log₁₀ of the sum of the ranks and subtracting 1. Note that SVM-F with and without log preprocessing obtains a perfect score.

### DETAILED DESCRIPTION OF THE INVENTION

The present invention addresses the problems existing in the state-of-art. In the first example, the method outputs a chart indicating in the mass spectra relevant sections where the biomarkers can be found.

Differently that existing methods that simply apply mathematical and statistical methods directly to mass spectral peaks, in this example we will show that by clustering peaks in a study window, we are able to take advantage of isotopic distribution and obtain improved results. This happens because the study window could be set to match the size of protein isotopic envelopes and cluster MS peaks that originated from the same protein/peptide isotopic envelope. This preprocessing helps reduce the dimensionality of the feature space, thus dropping the chances of overfitting.

Based on the MDA analysis one can find the regions of interest along the mass spectra having sites containing putative biomarkers to be identified, possibly by tandem mass spectrometry.

The reason for searching for isotopic envelopes within mass spectra data is that proteins do not appear in the mass spectrum with one single peak, but it should have an isotopic envelope, or a series of peaks having an exact 1 Da difference if the ion acquired a +1 charge, 0.5 difference for +2 charge and so on. Taking advantage of this fact increases the conviction to obtaining a protein signature, to reduce overfitting.

To exceed the limits of the state-of-art, having as main pillar the SVM analysis, or the maximum margin classifier, the invention is capable to deal with the sparseness, scarcity of the training set and assumes the lack of knowledge a priori of the quantity of the parameters required for the model.

The method of present invention is based on the principle of structural risk minimization, a new principle of induction originating from the statistical learning theory introduced by Vapnik and Chervonenkis, an evolution of the previous empiric risk minimization (ERM).

The present invention presents a method to avoid the loss of potential biomarkers through the use of the mass spectrometry technique, which uses the electrospray ionization, in order to allow ionization of the fluid phase to the gaseous phase of larger quantity of proteins, and thus permit the analysis by mass spectrometry.

As further demonstrated, a methodology of support vectors machines will be applied to classify samples of patients and control subject, by pre-selecting important information from the entire proteomic profile obtained by mass spectrometry.

The invention shall be now described with basis on examples, which should not be considered limiting of same.

### Example 1

### Collection of Blood Samples

30 blood samples from healthy blood donors and from 30 HD patients were collected immediately after the medical diagnosis but before the treatment initiation. Diagnosis and histological classification were confirmed by a hematopathologist, according to WHO the WHO (World Health Organization) criteria.

The presence of the Epstein-Barr (EBV) virus in the tumor cells were assessed through the immunohistochemical expression of the LMP protein −1 (latent membrane protein) with the use of the CSI-4 monoclonal antibody cocktail.

The evaluation of the patients included complete history, physical examination, several scorings and complete blood samples, biochemical files, serology for HIV, thorax radiography, thorax and abdomen computer-assisted tomography, bone marrow biopsy.

The serum extracted from the patients' blood samples was stored in aliquots at a temperature of approximately −80° C. The tumor's stage, development and other pathologic information about the patients were stored in a computer database.

### Example 2

### Analysis of the Proteome

Before analysis, an aliquot of each serum was thawed at room temperature and vortexed. Each sample was diluted 1:3 with Milli-Q graded water and desalted with Millipore's Zip-Tip C4 according to the manufacturer's manual. The final sample solution containing 2 μL was then diluted to 10 μL by adding the sample preparation solution.

### Example 3

### Obtention of Mass Spectra

All mass spectra were acquired using a quadrupole-TOF hybrid mass spectrometer (Q-TOF Ultima, Micromass, Manchester, UK) equipped with a nano Z-spray source operating in positive ion mode. The ionization conditions used included a capillary voltage of 2.3 kV, a cone voltage and RF1 lens of 30 V and 100 V, respectively, and collision energy of 10 eV. The source temperature was 80° C. and the cone gas was N₂ at a flow of 80 l/h; no nebulising gas was used to obtain the sprays Argon was used in the collision cell for ion collision cooling. External calibration with sodium iodide was performed over a mass range from 400 to 3000 m/z. All spectra were obtained with the TOF analyser in “V-mode” (TOF kV=9.1) and the MCP voltage set at 2.15 kV.

Each sample was injected twice into the mass spectrometer source with a syringe pump at a flow rate of 1 μL/min. during 2 min. using MCA mode. The whole system was washed with acetonitrile between injections. Data were collected from 400 to 3,000 m/z.

### Example 5

### Result of the Mass Spectrometer

Each of the serum samples was injected at least twice in the mass spectrometer through a syringe that is attached to the source receiver device with a 1 μL/min flow rate during some 2 minutes using the analyzer TOF MCA module. At the intervals between the first serum samples injection and a second serum sample, all the system must be washed with an adequate solution, such as, acetonitrile. The data to be analyzed was collected at the spectrum preferential interval comprised between 400 and 3000 m/z.

As to the mass spectrometry data at the interval of approximately 1200 to 2200 m/z, the data was submitted to a computing treatment in the Masslynx 3 program. Such computing program applies a smooth filter to reduce noises. The smooth filter was applied at 3 windows of the channel in order to use present invention method.

The multi charge spectrum was then converted to a single charge spectrum for the interval of 8 kDa to 250 kDa using a maximum entropy algorithm which belongs to the Masslynx computing program However, other non-convolution programs using a similar computing approach can be used, not limited to the application of the program used in current invention.

A 35 Da/channel preferential resolution with a damage model of around 0.75 Da with half the height width, minimum intensity beams of approximately 65% to left and right was configured for this spectrum. The Mass/Intensity data was exported to the text files.

The Mass/Intensity data was exported to the text files in the ASCII (.txt) format with the peaks resolution so to reach Dalton third decimal place of accuracy.

### Example 6

### Treatment of Data Obtained in the Spectrum Reading

The data obtained after the spectrum readings treatment was analyzed using the SVM strategy, which can be described as shown below (Vapnik, V.N.1995):

Given a set of linearly separable training on the space of characteristics: S={(x₁, y₁),(Xₙ, yₙ)} which results in an equation of a linear classifier W^{T}x+b=0, where w is the normal vector and b is a value attributed to a obliquity, for an unknown sample with input vector x, such must be classified with <w,x>+b>=1 and classified as −1 if: <w,x>+b<=−1.

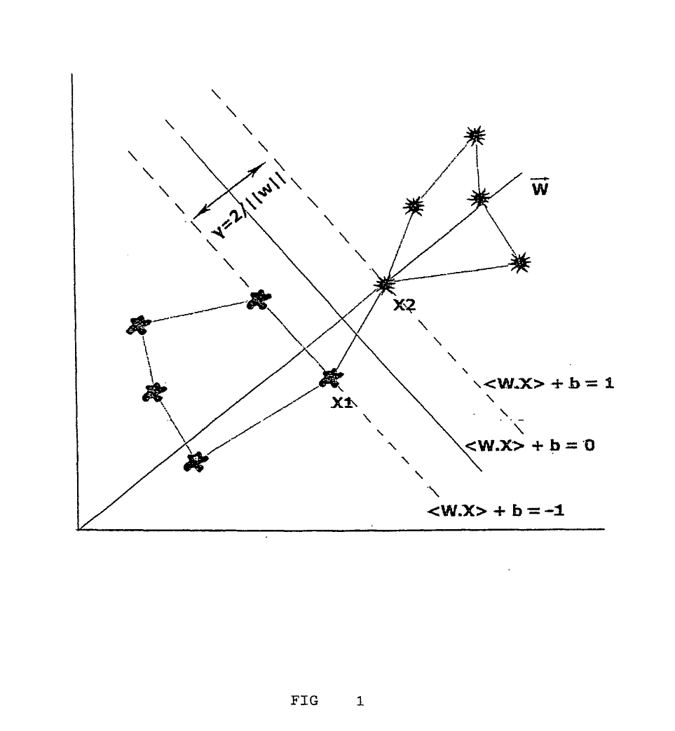

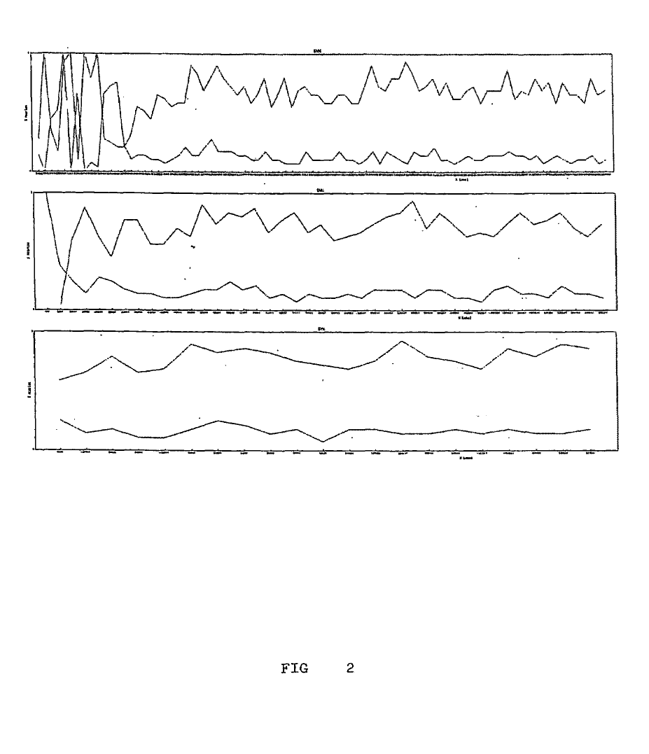

FIG. 1 geometrically shows that the margin can be calculated in accordance with following development stages after the normal vector definition:

<w·x₁>+b=1 (1.1)

<w·x₂>+b=−1 (1.2)

Subtracting eq. 1.1 from 1.2 yields

w<x₁−x₂>=2 (1.3)

Projecting the difference vector on the normal vector w:

$$\frac{1}{‖ w ‖} w \cdot < x 1 - x 2 >= \frac{2}{‖ w ‖} \qquad ( 1.4 )$$

The algorithm searches for the w's and b's space with the purpose of finding the maximum separation margin so to positioning a hyperplane. The better approach for this problem resolution is to converting such into a convex problem, in order to minimize a quadratic function under inequations restrictions. Therefore, such problem can be solved in its dual form applying the Lagrange treatment.

$$L ( w , b , α ) = \frac{1}{2} < {w}^{T} \cdot w > - {\sum }_{i = 1}^{i = n} {α}_{i} [ {y}_{i} ( < w \cdot {x}_{i} > + b ) - 1 ] \qquad ( 1.5 )$$

where: αᵢ ∃ 0 are the variables in its dual form or Lagrange multipliers.

The solution of this problem is equivalent to above equation resolution in its dual form (Wolfe), only written as a function of dual variables.

$$Min L ( α ) = {\sum }_{i = 1}^{i = n} {α}_{i} - \frac{1}{2} {\sum }_{j = 1}^{j = i} {y}_{i} {y}_{j} {α}_{i} {α}_{j} < {x}_{i} \cdot {x}_{j} > \qquad ( 1.6 )$$

Subject to: Σᵢ αᵢ yᵢ=0 e αᵢ≧0

The normal vector is obtained through this problem solution for the α* values

w=Σᵢαᵢ*yᵢxᵢ, for αᵢ*>0. (1.7)

In order to obtain a discriminating function f(x)=<w,x>+b the sloping parameter, b, must be computed. This is easily found applying the Karush-Kuhn-Tucker “supplementary condition”:

αᵢ(yᵢ(<w,xᵢ>+b)−1)=0. (1.8)

Above condition only applies to positive values of αᵢ. These multipliers are associated to the points that define the position of the hyperplane, and are thus called supporting vectors. In this way, if the slop parameter is correctly computed, we have αᵢ>0, yᵢ(<w,xᵢ>+b)=1, in order to satisfy the “supplementary” equation.

The approach for non separable data can be done by utilizing “slack variables” (ξ) and/or application of kernel functions in a non linear form (Ø) In this way, the problem optimization becomes:

yᵢ((wφ(xᵢ))+b≧1−ξᵢ, ξᵢ≧0, I=1, . . . , n (1.9)

The model allows some mistakes during the classification process so that a new function is then optimized and:

$${min}_{w , b , ξ} 1 / 2 {‖ w ‖}^{2} + C {\sum }_{i = 1}^{n} {ξ}_{i} \qquad ( 1.10 )$$

where C is a constant >0 and such related to the compromise between the empirical risk and the model complexity. The new formulation becomes.

$${L}_{D} ( α ) = {\sum }_{i = 1}^{n} {α}_{i} - \frac{1}{2} {\sum }_{i , j = 1}^{n} {α}_{i} {α}_{j} {y}_{i} {y}_{j} φ ( {x}_{i} {x}_{j} ) \qquad ( 1.11 )$$

### Subject to:

0≦αᵢ≦C,i=1, . . . n (1.12)

and also:

$${\sum }_{i = 1}^{n} {α}_{i} {y}_{i} = 0 \qquad ( 1.13 )$$

When introducing the “slack-variables”, the Lagrange multipliers value is limited to a maximum of C (αᵢ≦C).

### Example 7

### Preparation of the SVM Data

The “ACESO” software (navigator under the spectrum set), developed in current work, was used to normalize the spectra intensity for values between 0 and 1, having, as a result of the maximum ion current, the value 1, adequate to the algorithm application. Additionally, an average value for the spectrum data is created based on the mass spectrum data, multiplied for each sample.

For the peptides spectra (approximately 400-1200 m/z), the software configures the spectrum data so they have around 1 Da of resolution by summing intermediate values. In this way, the “ACESO” software is actually formed by data in an optimized manner to classify and interact with the next stage, with SVMPP, to classify the information based on the “leave one out” approximations.

The leave-one-out cross validation (LOO) is done by excluding one data file from the dataset, and using the rest as a training set. The algorithm builds a support vector model based on the training set and then tries to properly classify the excluded file by establishing on what side of the hyperplane it is placed. The process is repeated until all samples from the dataset have gone through the test. This enables to evaluate the error within the dataset, or the empirical risk, by verifying the percentage of misclassified samples.

The algorithm of the current invention uses small spectrum portions as training set, so to search for regions where better accuracy can be obtained.

The method accuracy is calculated as true positive (TP), true negative (TN), false positive (FP) and false negative (FN) functions, as shown in the equation:

Accuracy=(TP+TN)/(TP+TN+FP+FN).

### Example 8

### Obtention of Biomarkers

The software “ACESO” in another moment was used to promote the search for biomarkers, through the analyses of a small pre-scheme “window of studies”. The window of studies is a small extension in m/z which opening is defined by the user

Two distinct LOO analyses were carried out for all study windows so that it could stand in opposition to 59 trained subjects schemes in the same window extension; one first group for the serum control samples and a second group for the patient's serum samples containing the Hodgkin Disease.

The MDA analyses used a window for the approximate spectrum values of 100 m/z, 20 m/z and approximate spectrum values of 10 m/z to approximately 400 to 1200 m/z of extension and approximately 2,240 and 4,480 for 8 kDa at about 200 kDa extensions.

The MDA data production is given by the report text file so to classify all inputs from all windows of studies, and a chart in which the ordinary distance for all approximate values from 0 to 100 represents the “healthy material” percentage classified in each LOO analysis.

The chart abscissa had its extension analyzed in conformity with the data obtained on the total spectrum. Each and every “leave one out” analyzed data relative to each and every analyzed group were plotted and connected so to form a shortcut, which is shown in the chart abscissa.

The MDA data chart presents two parallel lines on x axis, where, in an ideal case, the first line across x axis at 100% and the second line across y axis at 0%. The upper line must represent the blood samples of the control patient group, so to indicate that about 100% of the control patients were classified as “healthy”.

The lower line must represent the blood samples of the HD patients group, meaning, non “healthy patients”, so as to indicate that 0% of this group of patients were classified as “healthy”.

However, in a current data base, this result is not likely to happen. Maximum convergence points between the two straight lines of the chart must be visible, so as to represent the spectrum portion where most of the samples from control subjects and samples from HD patients have been “correctly” classified.

These “hot spots” indicate regions in the chart, where the search for peaks differently expressed on the spectrum for biomarkers representation is the ideal. For this reason, the SVM extension technique was labeled Maximum Divergence Analyses (MDA).

The algorithm used for the supporting vector mechanism was able to classify approximately 93% of the control patients' blood samples and approximately 88% of the Hodgkin Disease-infected patients' blood samples using the “leave one out” technique, with approximately 90% accuracy.

The control subject samples were classified either as belonging to a healthy class or sick class. The HD patients that were incorrectly classified are the patients: 4, 5, 16, 20, the serum samples identified as 5, 16 e 20 belong to HIV+ patients.

The chances to select 4 patients, being 3 or more thereof, HIV+ patients for a population of 30 patients blood samples, which already had about 6 HIV+ patients is smaller than 1%. This fact indicates that the infection caused by HIV leads to a modification in the protein associated with the mass spectrum for Hodgkin disease patients.

Within the HD group, the patient 4, who shows a histochemistry-immune negative test for the EBV virus, has also shown that, the progression stage of HD was in its early phase, which in turn suggests why the incorrect classification could have occurred.

This methodology can be extended to the creation of other models, for example, the multiple diagnosis. The current method of diagnosis system based on the SVM technique can be used for diagnosis on population which has DH patients and DH+HIV patients.

On a second 400 to 1200 m/z spectrum reading interval, the supporting vector of the algorithm of supporting vector mechanism classified all control subjects and Hodgkin Disease patients “correctly” through the LOO technique. This result shows that for this spectrum interval, the data obtained indicates that the extension of approximately 400 to 1200 m/z is the most recommended extension in the classification use for the Hodgkin Disease associated to other pathologies than high molecular mass data, as listed in the state-of-art.

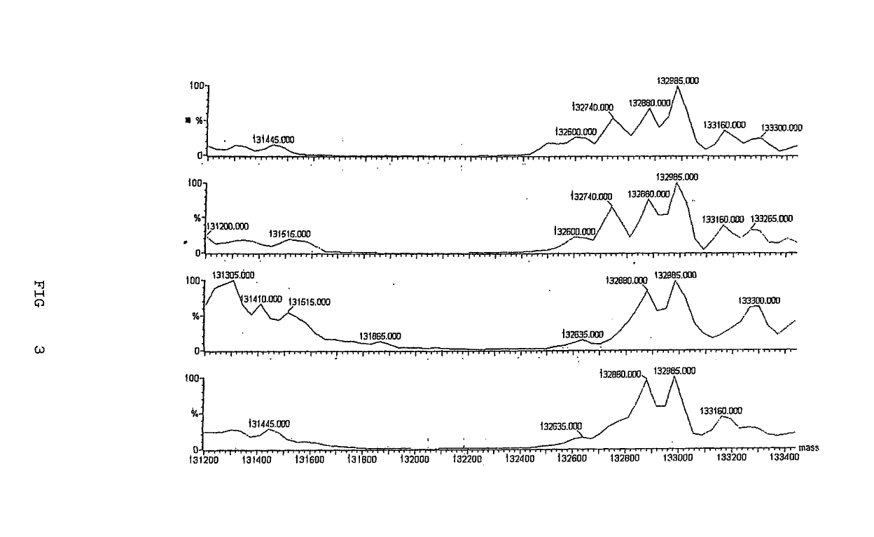

FIG. 2 shows the MDA analyses results with the use of an opening on the window of studies of approximately 2240 and 4480 Da. The analyses for the window of studies of approximately 4480 Da shows an important divergence region around the area of approximately 130 kDa

Approximately at 2240 Da, the MDA analyses result confirms this key segment approximately in between the values of 131 kDa and 133 kDa, so as to present an optimum divergence. The MDA analyses in this region for all serum samples from control patients and Hodgkin Disease infected patients express different peaks of approximately 132, 740 Da, 97% of Hodgkin Disease infected patients and 97% for the serum of control patient's blood samples, these peaks are not expressed.

The patients number 305 and again 16 were erroneously classified on the other point of maximum divergence between the spectra.

An efficient way to examine many spectra in the search for biomarkers is the comparison of the average of all corresponding spectra at each peak, for each class.

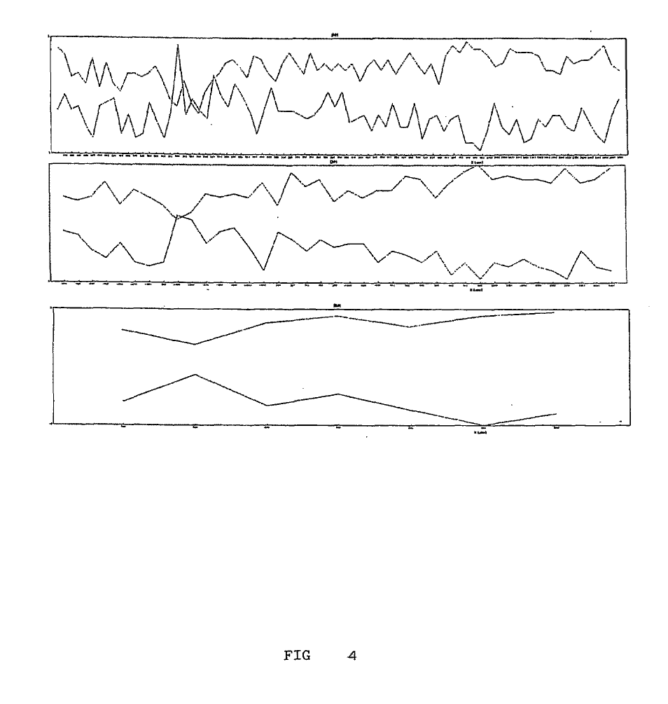

The spectrum average was built through the determination of the mass intensity average of each peak for each one of the groups. The mass spectrum for this region is shown on FIG. 3, the peak presence expressed in approximately 132, 740 Da for blood samples of control patients is differently expressed for blood samples of Hodgkin Disease infected patients.

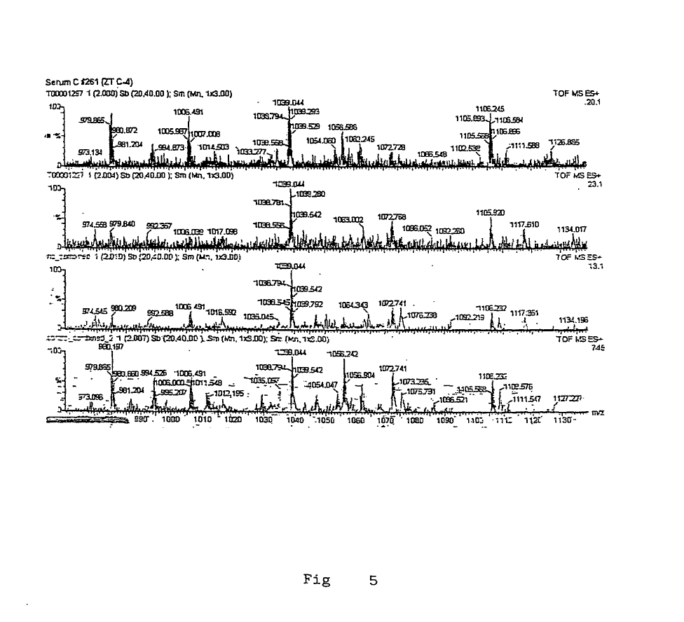

The MDA analyses for the windows of studies of approximately 20 m/z and 10 m/z clearly shows the extension segment divergence of approximately 980 m/z to 1000 m/z with approximate maximum divergence between 990 m/z-1000 m/z, as shown in FIG. 4. This region of the spectrum indicates the indicative site to potential biomarkers for clinical diagnosis.

According to FIG. 5, the mass spectrum for a region of approximately 980 m/z shows the presence of isotopic envelops differently expressed in approximately 980 and 994 m/z in blood samples of control patients Such isotopic envelops are not expressed in blood samples of Hodgkin Disease patients.

By the performance of approximation of the “leave one out” analyses only under the segment between about 990 and 1,000 Da, approximately 97% of patients infected by the Hodgkin. Disease were “correctly” classified just like approximately 91% of the control patients' blood sample, as shown in FIG. 5. The control patients' blood samples, due to the inaccurate classification, are 5 and 299. One incorrect classification of the blood samples from patients #9 with Hodgkin Disease has shown a negative histochemistry-immune for the EBV virus.

To promote the study of the control material samples 5 and 299, the PCR test was performed for the EBV virus, where the positive results shown for both the control patient 5 and 299 serum samples were confirmed. A large number of patients with Hodgkin Disease also showed a high rate of EBV antibody in their serum.

The classification “not expected” of patients 5 and 299 was due to the presence of EBV high rates in the patients' serums. The proposed model on the current invention was trained based on patients with HD, who also had the EBV virus. Thus, the presence of the EBV virus was detected in their serums, which led to the incorrect classification of these patients.

The evolution of the large spectrometric masses both for the blood samples of the HD patients and for the blood samples of control subjects, recognized as control matter, prove that the model was capable to classify individuals with closer accuracy (400-1,200 m/z), than in the largest molecular mass zone.

According to the data achieved for the spectrum extended to approximately 1200-2200 m/z as shown on FIG. 4, a satisfactory number of correct achievements was reached in the classification process, but the method was able to reveal “hot spots” on the spectrum. These “hot spots” are able to separate the results obtained with control patients, those of HD patients, besides discriminating patterns originating from HIV virus and EBV virus.

The MDA analyses can be construed as a selection aspect, and each isolated aspect represents a new biomarker for medical diagnosis. In the present invention, about 100% of the control matter samples and Hodgkin Disease infected patients samples were correctly classified in the approximate extension of 400-1200 m/z.

Through the method developed by the present invention, a quick cancer diagnosis is possible allowing a customized treatment.

### Example 1

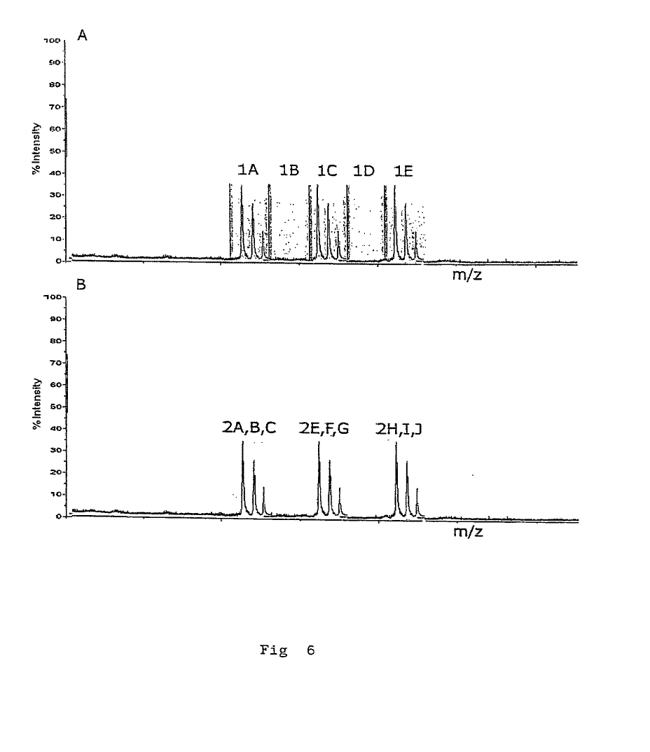

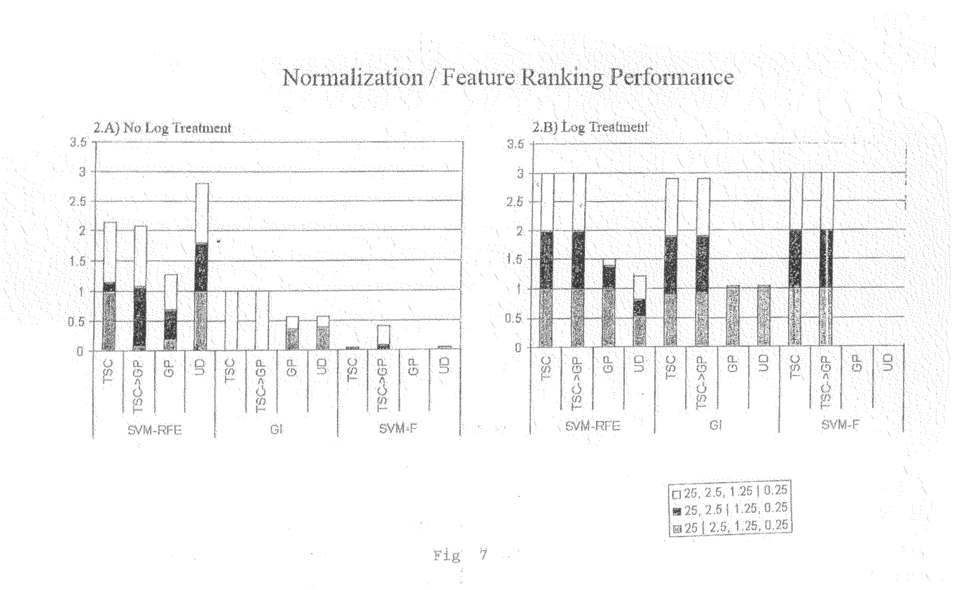

Before demonstrating other methods of pre-clustering peaks, we clarify the concepts that went on and show a few variants by referring to FIG. 6.

FIG. 6. Demonstration of two methods for mapping mass spectra peaks to the feature space. Sections A and 6B show two simplified hypothetical mass spectra containing three peptides. The Y axis indicates MS signal intensity and the X axis the mass to charge ration of the ion (peptide). For the sake of simplicity, let all three peptide have a charge of +1, making the x axis represent mass. Each peptide appears as three consecutive peaks with a +1 Dalton shift in mass; characterizing an isotopic envelope.

On the top example, study windows are generated as to match the span of isotopic envelopes. A value for each study windows is addressed by integrating the MS signal within the window. Case A could be coded/clustered as an input vector according to the following example: 1:15 2:0 3:13 4:0 5:16 where the numbers before the “:” indicate a respective dimension in the feature space and the numbers following the “:”, hypotheticaly created, indicating the window value. The dimension for each feature could be assigned according to the initial X value comprehended within the window.

The lower mass spectrum indicates another method for safely compressing the mass spectra data to the input vector format. A heuristics is applied to identify the peaks belonging to an isotopic distribution. Then an input vector is coded according to the example: 1:15 2:13 3:16 having thee dimension value assigned according to the mass of the monoisotopic peak for each feature.

It should be noted that both methods show ways to compress thousands of peaks contained within the mass spectra to features that correctly represent the corresponding peptides, however in a lower dimensional feature space to avoid overfitting, so feature selection can be applied.

### Example 2

To exemplify another method of the present invention, it will be study a type of database. The first one, above exemplified, is originated from serum samples from thirty control subjects and thirty Hodgkin's disease (HD) patients (MS data). The second database (composed of LC/LC/MS/MS data) is obtained from yeast lysate with artificially spiked proteins, and we show, according to the proposed methodology in the invention, that by defining the various “study windows” of interest and then searching for patterns, we were able to detect how many and which proteins were spiked in the yeast lysate.

### Example A

### Searching for Differences in LC-LC-MS-MS Data, Grouping the Data by Spectral Counts and Searching for Patterns Basing on the Structure Risk Minimization Principle

The need for higher sensitivity, better reproducibility and the ability to analyze samples of greater complexity have led to the use of liquid chromatography with electrospray mass spectrometry (LC-MS) to profile digested protein mixtures. Elimination of the data dependent tandem mass spectrometry process enhances the detection of ions since the instrument spends less time acquiring tandem mass spectra and the lack of alternating MS and MS/MS scans improves the ability to compare analyses. Becker et al used ion chromatograms from an LC-MS system to identify differences between samples including complex mixtures such as digested serum with reasonable variation in the analyses (39). Wiener et al. used replicate LC-MS analyses to develop statistically significant differential displays of peptides (40). These approaches divide the comparison and identification processes to first identify chromatographic and ion differences and then to identify the peptides responsible for the differences in much the same strategy as used in 2-DGE analyses. To reduce comparison errors and ambiguities between samples, chromatographic peak alignment is increasingly used (41-47).

Multi-dimensional liquid chromatography coupled with tandem mass spectrometry has been used to analyze proteolytically digested complex protein mixtures (48). This approach has been used to analyze protein complexes, organelles, cells and tissues and to compare differences between samples (49-51). By using the numbers of tandem mass spectra obtained for each protein or “spectral counting” as a surrogate for protein abundance in a mixture, Liu et al. demonstrated the use of LC/LC/MS/MS to obtain semi-quantitative data on mixtures (52). Because of the more complex nature of the 2-D LC method and the alternating acquisition of mass spectra and tandem mass spectra, chromatographic alignment is far more complicated than by using LC-MS and therefore data are most often analyzed from the perspective of tandem mass spectra and identified proteins. Two issues with the use of LC/LC/MS/MS analyses to compare samples involve the normalization of spectral counting data and the identification of differences between samples. Here we evaluate a machine learning approach to facilitate classification and sample comparison of shotgun proteomics data Our aim was to determine whether spectral counting could pinpoint protein markers that were added at different concentrations into complex protein mixtures (yeast lysate). To achieve this, we evaluated different combinations of normalization/feature selection methods. To identify the combination that best performed on our dataset we used the support vector machine (SVM), the leave-one-out (LOO) cross-validation method and the Vapnik-Chervonenkis (VC) confidence to estimate the upper bounds on generalization performance in terms of a classification function's separating margin distribution (32).

### Example A.1

### MuDPIT Spectral Count Acquisition from Yeast Lysate having Spiked Proteins

Four aliquots of 400 μg of a soluble yeast total cell lysate were mixed with Bio-Rad SDS-PAGE low range weight standards containing phosphorylase b, serum albumin, ovalbumin, lysozyme, carbonic anhydrase and trypsin inhibitor at relative levels of 25%, 2.5%, 1.25%, and 0.25% of the final mixtures' total weight, respectively (FIG. 1.1). Each sample was sequentially digested, under the same conditions, with Endoproteinase Lys-C and trypsin. Approximately 70 μg of digested peptide mixture were loaded onto a biphasic (strong cation exchange/reversed phase) capillary column and washed with a buffer containing 5% acetonitrile, 0.1% formic acid diluted in DDI water. Two-dimensional liquid chromatography (2DLC) separation and tandem mass spectrometry conditions as described by Washburn et al were used for the analysis (54) (FIG. 1.2) The flow rate used at the tip of the biphasic column was 300 nL/min when the mobile phase composition was 95% H₂O, 5% acetonitrile, and 0.1% formic acid. The ion trap mass spectrometer, Finnigan LCQ Deca (Thermo Electron, Woburn, Mass.) was set to the data-dependent acquisition mode with dynamic exclusion turned on. One MS survey scan was followed by four MS/MS scans. The target value was 1×10⁸ for MS and 7×10⁷ for MS/MS. Maximum ion injection time was set to 100 ms. Each aliquot of the digested yeast cell lysate was analyzed 3 times. The data sets were searched using a modified version of the Pep_Prob algorithm (55) against a database combining yeast and human protein sequences (FIG. 1.3). The sequences of phosphorylase b, serum albumin, ovalbumin, carbonic anhydrase, trypsin inhibitor, lysozyme, and some common protein contaminants (e.g., keratin) were added to the database. The result files use the .txt format and were named after their acquisition date followed by a “−” and either 1, 5, 10 or 100 to indicate the percentage of markers added (0.25, 1.25, 2.5, and 25% respectively).

### Example A.2

### Generation of the Study Dataset

A program named MPDiff (MuDPIT Difference Finder) created for this study was employed to parse the output of protein identifications into a format more suitable for the feature selection/machine learning process. Firstly, MPDiff reads the DTASelect files (56) placed in a selected directory and generates an output file called “index.txt”. The latter lists all the proteins identified in all the MuDPIT runs-assigning a unique Protein Index Number (PIN) to every identified protein. Secondly, the program generates a sparse matrix (model.txt) where each row is an input vector (IV). An IV contains the spectral count information acquired during one MuDPIT run by listing PINs followed by the corresponding spectral counts. We also refer to each component of the IV, a PIN, as a feature. The classifications performed here are limited to two-class classification problems, the two classes being referred to as the positive (+) and negative (−) classes. An example of an IV having spectral count values of 3, 5 and 6 for PINs 1, 2 and 3 respectively is “+1 1:3 2:5 3:6”; the +1 indicates that the IV belongs to the positive class.

The sparse matrix generated for this study is composed of 15 IVs, obtained from 15 independent MuDPIT runs with different percentages of protein markers spiked in the yeast lysate (4 runs with spiked markers representing 25% of the total protein content, 4 with 2.5%, 3 with 1.25% and 4 with 0.25%). We note that each IV had approximately 1000 PINs and a total of 2181 PINs were detected among all 15 IVs, showing that many proteins were not identified in all runs. Since our aim was to verify whether the feature selection methods were able to pinpoint proteins having different expression levels in complex mixtures we created four sparse matrixes. Each matrix is identical to all others except for the IV class labels. In the first matrix; the input vectors originated from the 25% protein spiking were labeled as belonging to the positive class and all the rest as to the negative class. On the second matrix, the 25% and the 2.5% input vectors were labeled as from the positive class and the rest from the negative class; and so forth From here on we refer to each matrix as a training dataset to be used in a classification problem.

### Example A.3

### Data Normalization

The normalization methods described below were carried out using MPDiff

### A.3.1 Normalization by Total Spectral Counting (TSC)

Let SCᵢⱼ be the spectral count associated with PIN i in IV j. The total spectral count of IV j is

$${TSC}_{j} = {\sum }_{i} {SC}_{ij} . \qquad ( 1 )$$

The normalization by TSC of IV j is obtained by performing

$${SC}_{ij} ← \frac{{SC}_{ij}}{{TSC}_{i}} for all i . \qquad ( 2 )$$

### A.3.2 Golub's Normalization/Preprocessing (GP)

The following preprocessing step was used by Golub when analyzing microarray data (57). For PIN i let μᵢ be the mean of SCᵢⱼ over all j, and similarly σᵢ the standard deviation. Normalization is achieved by performing

$${SC}_{ij} ← \frac{{SC}_{ij} - {μ}_{i}}{{σ}_{i}} \qquad ( 3 )$$

for all j. The mean of the resulting SCᵢⱼ, over all j is then zero and the standard deviation is 1. We note that GP is carried out over each matrix column while TSC is performed on each matrix row.

### A.3.3 Hybrid Normalization (TSC→GP)

This is obtained by TSC followed by GP.

### A.3.4 Log Preprocessing

Taking the logarithm of the spectral count data was also evaluated as a preprocessing step before the above normalization steps,

SCᵢⱼ←ln(SCᵢⱼ) (4)

Our aim was to increase the signal of the PINs with low spectral counts with respect to the “highly abundant” PINs.

### A.4 Feature Selection/Ranking

For this study, we evaluated Golub's correlation coefficient (GI), SVM-RFE and a method we call forward-SVM (SVM-F). These feature selection/ranking methods were carried out using MPDiff.

### A.4.1 Golub's Correlation Coefficient (GI)

For PIN i, Golub's correlation coefficient (58) is defined by

$${GI}_{i} = \frac{{μ}_{i}^{+} - {μ}_{i}^{-}}{{σ}_{i}^{+} + {σ}_{i}^{+}} , \qquad ( 5 )$$

where μᵢ⁺, μᵢ⁻, σᵢ⁺, and σᵢ⁻, are the means and standard deviations corresponding to the positive (+) or negative (−) class of PIN i. The larger a positive GIᵢ, the stronger the PINs correlation with the positive class, whereas the larger a negative GI₁ the stronger the correlation with the negative class. For our goal of class-independent feature ranking we simply took absolute values.

### A.4.2 Support Vector Machine (SVM)

SVMs constitute a supervised learning method based on statistical learning theory and the principle of structural risk minimization (59) SVMs have been successfully used in a number of applications, including particle and face identification (60), text categorization (61), database marketing, and extensively in bioinformatics for the prediction of protein folds (62), siRNA functionality (63), rRNA, DNA and DNA-binding proteins (64), etc. An SVM model is evaluated using the most informative patterns in the data (the so-called support vectors) and is capable of separating two classes by finding an optimal hyperplane of maximum margin between the corresponding data.

Briefly, in the linearly separable case the SVM approach consists of finding a vector w in the feature space and a scalar b such that the hyperplane [symbol] +b can be used to decide the class, + or −, of input vector x (respectively if [symbol] +b≧0 or [symbol] +b<0). During the training phase, the models compromise between the empiric risk and its complexity (related with generalization capacity) is controlled by a cost parameter C, that is a constant >0. We refer the reader to Vapinik's book for further details of the SVM approach, including how to obtain w and b from the training dataset (32). To carry out SVM modeling, MPDiff wraps SVMlight (65).

### A.4.3 SVM-F Feature Ranking

SVM-F feature ranking is performed on the SVM model of the whole training set. If w is the corresponding vector in the feature space and wᵢ is the coordinate in w that corresponds to PIN I, SVM-F ranks features in decreasing order of wᵢ². Clearly the lowest ranking PINs influence the hyperplane the least. SVM-F's output consists of the PINs ordered and listed side by side with their ranking score.

### A 4.4 SVM-RFE

SVM-RFE consists of recursively applying SVM-F on a succession of SVM models. The first of these corresponds to the whole training set; for k>1, the kth SVM model corresponds to the previously used training set after the removal of all entries that refer to the least-ranking PIN (according to SVM-F). The SVM models are then built on successively lower-dimensional spaces. Termination occurs when a desired dimensionality is reached or some other criterion is met. Since features are removed one at the time, an importance ranking can also be established.

### Example A.5

### Evaluation of Combined Normalization and Feature-Ranking Methods

Combinations of the methods described were used to verify whether the spiked proteins could be pinpointed when comparing mixtures having markers spiked with different concentrations. In the ideal case, the four spiked proteins should achieve the top feature ranks. The ranks of the spiked proteins are listed in Tables S-I and S-II for the various method combinations and concentration comparisons. The tables also show, in each case, a penalty score (Pscore) used to evaluate each method. This score plus one is the logarithm to the base 10 of the summed ranks of the four markers. Clearly, the ideal ranks yield a (minimum) Pscore of 0.

### Example A.6

### Evaluation of The Normalization Methods

By using only the spectral counts of the spiked proteins, SVM models were calculated varying its C's from 2 to 100 with a step of 2 for all normalization methods. The C's that achieved a minimum LOO error or VC confidence were recorded. In either case, the LOO error, the VC confidence and the number of support vectors of the model were also recorded (Table S-III). We note that LOO error and VC confidence are respectively ways of measuring a model's empirical risk (the error within the dataset) and how much may be added to that risk as the model is applied on a new dataset (generalization capacity).

The LOO technique consists of removing one example from the training set, computing the decision function with the remaining training data and then testing on the removed example. In this fashion one tests all examples of the training data and measures the fraction of errors over the total number of training examples.

The models VC confidence has roots in statistical learning theory (32) and is given by

$$VC confidence = \sqrt{\frac{h ( ln ( 2 l / h ) + 1 ) - ln ( η / 4 )}{l}} , \qquad ( 6 )$$

where h is the VC dimension of the models feature space, 1 is the number of training samples and 1-η being the classification function's desired confidence. We recall that, given an SVM model, the VC dimension is a known function of the separating margin between classes and the smallest radius of the hyphersphere that encompasses all input vectors.

### Example A.7

### Predicting how Many Proteins were Spiked

Feature ranking can be combined with methods that predict how many features are significant. Here, predicting the number of features is equivalent to estimate how many proteins were spiked. All feature ranking methods we used output a two-column list having features (PINs) ordered by their ranks in the first column and the method's score for each PIN in the second column. The number of spiked proteins was estimated by locating in this output list, the two consecutive rows that present the greatest difference in score values. The number of features is then computed by counting how many features have scores above this gap's upper limit.

### Example A.8

### A.8.1 Evaluation of the Feature Selection/Ranking Methods

An efficient feature ranking criterion should select the features that best contribute to a learning machine's ability to “separate” data (e.g. cancer vs. normal), reduce pattern recognition costs and make the model less prone to overfitting Translational studies usually hold limited amount of samples and have a high dimensionality (many features), making feature selection and evaluation of the generalization capacity imperative steps. By spiking proteins within yeast lysates and detecting them, we perform a proof of principle of the potential of using spectral counts and SVM to identify differences and perform classification in proteomic profiles.

To exemplify the importance of an appropriate feature selection method, we recall that Guyon et al. applied SVM-RFE to colon cancer microarray data (n=62 d=2000), selecting 4 genes that yielded a 98% classification accuracy, while the baseline method only reduced the dataset to 64 genes with 86% accuracy (66). It is believed that SVM outperforms most methods (i.e. linear discriminant analysis, neural networks, PCA), especially for sparse and high-dimensional datasets, because it simultaneously minimizes the error contained within the dataset (empirical risk) and a function that bounds the generalization error for future samples.

Both SVM-F and SVM-RFE are multivariate feature selection methods (they use combined information from all the features), while GI is a univariate feature selection method and such is influenced by only one feature at a time. In our hands, for the yeast MuDPIT spectral count dataset, both Golub's preprocessing, with and without log preprocessing and the use of raw data with the log preprocessing followed by SVM-F achieved a perfect score, pinpointing all spiked proteins for all configurations over the 10² dynamic range tested. These results are shown in Tables S-I, S-II and FIG. 6.

Overall, the greatest difficulties found in the methods were in finding the spiked markers for the 25|2.5, 1.25, 0.25 separation. We hypothesize that this originates from limitations in both the feature selection methods and the experimental procedure used From the machine learning perspective, according to Cover and Van Campenhout no non-exhaustive sequential feature selection procedure is guaranteed to find the optimal feature subset or list the ordering of the error probabilities (67). We do not use exhaustive feature searching since the number of subset possibilities grows exponentially with the number of features; this method quickly becomes unfeasible, even for a moderate number of features. Less abundant proteins are not identified in every MuDPIT analysis, generating a bias toward the acquisition of more abundant peptide ions. Thus, less abundant proteins are identified by less peptides and their identifications can sometimes be suppressed by peptides from highly abundant proteins. Liu et al. addressed the randomness of protein identification by MuDPIT for complex mixtures. (68). The input vectors originating from the 25% spiking show that less PINs were identified during these runs (˜700), contrasting with ˜1000 PINs from the other runs. This lack of PINS may have driven the SVM-RFE toward an “undesired direction” while recursively eliminating the features. During the RFE computation and before narrowing down to ˜600 features, the weights of the normal vector (w) still included the spiked proteins among the most important features.

Although we have successfully identified the spiked proteins, there could be variants of the presented method that could perform better for datasets of different nature The methods employed here are “greedy”, in the sense that they quickly narrow down to what could be local optimal solutions. The quest for the global optimum in high-dimensional feature spaces still remains a challenge for pattern recognition. Distributed computing, coupled with algorithms that can efficiently rake the feature space (genetic algorithms (18;69), swarms (70), etc.), holds promises for proteomics of mining datasets more complex than the ones we addressed. Among the possibilities lies the application of feature selection methods in raw MuDPIT data (MS and MS/MS mass spectra). The patterns search would rely on the counting of mass spectral peaks with their respective ion intensities instead of how many times a specific protein/peptide was identified. Raw data studies hold the promise to identify post-translational modifications and draw database independent conclusions. To search for patterns within this type of dataset, genetic algorithms with SVM-based fitness functions could be employed, and constitute a path to better study the nature of pathogen interactions and diseases. The different solutions and correlations provided by these methods could also help identify protein-protein interactions.

### Example A.9

### Evaluation of the Normalization Methods Regarding Dataset “Separability”

Given that more than one method is able to select the spiked proteins, which one is best? Since spiked markers exist in contain different concentrations in each class and that spectral counts correlate with protein abundance, there should be a linear function capable of separating the input vectors containing only the spectral count information of the spiked proteins. To further evaluate the generalization capacity of the model, we used the VC confidence.

Both GP and log preprocessed data allowed SVM-F to correctly select the spiked proteins and yielded a 0% LOO for all spiking configurations (Table S-III). VC confidence shows that for the 25|2.5 and the 2.5|1.2.5 separations under GP there is a greater capacity than for 1.25|0.25, thus here the lower masses made it harder for GP preprocessing. On the other hand, the LN preprocessed data separated better in the lower masses, probably because of the nature of the log function which discriminates lower values better than larger values.

### Example A.10

### Predicting the Number of Spiked Proteins

Overall, according to our benchmarks strategy, GP normalization followed by SVM-F was the method that obtained a perfect score for the yeast MuDPIT dataset. The method used to predict the number of spiked markers described in section 2.7 was applied to the GP/SVM-F results and it correctly identified the number of spiked markers as being 4 for all three separations of spiked marker possibilities.

The acquisition of data using shotgun proteomics provides information about the abundance of proteins based on the number of tandem mass spectra acquired per protein. In the course of a MuDPIT experiment this information is automatically acquired. In this study we set out to address whether the data from spectral counts can be normalized and then classified using pattern recognition techniques The above results conclude that GP followed by SVM-F applied to the yeast MuDPIT spectral count dataset is an effective method for finding differences in this type of data. The methodology described was also capable of correctly identifying how many markers were spiked in the lysate. Addressing the number of features is important especially to avoid overfitting. It is expected that the presented method should perform satisfactory for other yeast experiments where data is similarly experimentally acquired. It is expected that this method should also achieve a good performance for proteomics datasets of similar nature.

Most importantly, we show a method to validate a computational approach for a proteomic study. A dataset's high dimensionality, scarceness, and lack of a known a priori probability distribution could easily “play tricks” on well founded pattern recognition techniques. Thus, we also note the importance of optimizing ones pattern recognition method with the nature of their experiment and data acquisition methodology. As shown in our results, even the state-of-the-art SVM-RFE failed to obtain satisfactory results for our dataset, however, according to Guyon et al. it outperformed various other methods in their microarray data (71). Interestingly, the same GP followed by GI also evaluated in Guyon et al. outperformed SVM-RFE for our dataset. An experiment using SVM-RFE on yeast having the proteomic profile mapped with MuDPIT/spectral could lead to false conclusions. This shows that pattern recognition methods can perform differently on datasets of distinctive nature pointing out that there is no “one suits all” method. Thus, it becomes imperative to previously validate a computational approach with ones experimental methodology before drawing conclusions when dealing with complex datasets

### Table S-I. Normalization and Feature Selection Results (C=100)

The first column lists the spiked proteins we tracked; phosphorylase b (PHS2), serum albumin (ALB), carbonic anhydrase (CAH) and trypsin inhibitor (ITRA). The top row lists the normalization methods; total spectral count (TSC), Golub's preprocessing (GP) and TSC followed by GP GI, SVM-F and SVM-RFE stand for Golub Index, Forward SVM and SVM-Recursive Feature Elimination; the three feature selection methods. The three yellow rows that span across the table indicate the different matrixes analyses (refer to the end of section 2.2) (i.e. 25|2.5, 1.25, 0.25 indicates that the input vectors decurrently from yeast lysate having 25% of their protein content from spiked markers composed the positive class). The numbers indicate the rank of the protein markers among the various other proteins present in the yeast lysate. To qualify the method combinations, we used a penalty score (Pscore) that is calculated by the Log (sum of the ranks) −1. Here we used 10 as the log's base; thus for a perfect score the ranks would add up to 10 (4+3+2+1), the Log would yield 1 and after the subtraction of 1, the final Pscore would be 0 The Tscore is the sum of the Pscores for a given method and is used to quickly browse who performed best.

TABLE S-II
Normalization and Feature Selection Results
(C = 100) having LN as a preprocessing step.
Refer to the legend of Table S-I. Logₑ was used as a
preprocessing step before qualifying the feature selection method.
No Log treatment

| TSC | | | GP | | | TSC->GP | | | UD | | |
|---|---|---|---|---|---|---|---|---|---|---|---|
| | | SVM- | | | SVM- | | | SVM- | | | SVM- |
| GI | SVM-F | RFE | GI | SVM-F | RFE | GI | SVM-F | RFE | GI | SVM-F | RFE |

Separating condition 25|2.5, 1.25, 0.25

| | | | | | | | | | | | | |
|---|---|---|---|---|---|---|---|---|---|---|---|---|
| PHS2 | 3 | 3 | 342 | 2 | 4 | 6 | 3 | 1 | 4 | 2 | 3 | 1242 |
| ALB | 1 | 1 | 340 | 1 | 2 | 7 | 1 | 2 | 1 | 1 | 1 | 469 |
| CAH | 4 | 4 | 343 | 17 | 3 | 2 | 4 | 4 | 5 | 18 | 5 | 1261 |
| ITRA | 2 | 2 | 341 | 3 | 1 | 1 | 2 | 3 | 2 | 3 | 2 | 476 |
| Pscore | 0 | 0 | 2.14 | 0.36 | 0 | 0.20 | 0 | 0 | 0.08 | 0.38 | 0.04 | 2.54 |

Separating condition 25, 2.5|1.25, 0.25

| | | | | | | | | | | | | |
|---|---|---|---|---|---|---|---|---|---|---|---|---|
| PHS2 | 2 | 5 | 7 | 4 | 4 | 14 | 2 | 6 | 56 | 4 | 4 | 20 |
| ALB | 1 | 1 | 1 | 1 | 2 | 1 | 1 | 3 | 18 | 1 | 1 | 14 |
| CAH | 4 | 3 | 4 | 2 | 1 | 4 | 4 | 1 | 23 | 2 | 3 | 16 |
| ITRA | 3 | 2 | 2 | 3 | 3 | 12 | 3 | 2 | 22 | 3 | 2 | 15 |
| Pscore | 0 | 0.04 | 0.15 | 0 | 0 | 0.49 | 0 | 0.08 | 1.08 | 0 | 0 | 0.81 |

Separating condition 25, 2.5, 1.25|0.25

| | | | | | | | | | | | | |
|---|---|---|---|---|---|---|---|---|---|---|---|---|
| PHS2 | 352 | 4 | 173 | 10 | 4 | 18 | 352 | 7 | 15 | 9 | 4 | 315 |
| ALB | 348 | 1 | 8 | 2 | 1 | 2 | 348 | 5 | 54 | 2 | 1 | 313 |
| CAH | 357 | 3 | 6 | 1 | 2 | 1 | 357 | 3 | 61 | 1 | 3 | 312 |
| ITRA | 361 | 2 | 12 | 3 | 3 | 17 | 361 | 6 | 43 | 3 | 2 | 314 |
| Pscore | 2.15 | 0 | 1.30 | 0.20 | 0 | 0.58 | 2.15 | 0.32 | 1.24 | 0.18 | 0 | 2.10 |
| Tscore | 2.15 | 0.04 | 3.59 | 0.56 | 0 | 1.27 | 2.15 | 2.4 | 2.4 | 0.56 | 0.04 | 5.45 |

TABLE S-III
Linear SVM separability analysis.
Logₑ treatment

| | | | |
|---|---|---|---|
| TSC | GP | TSC->GP | UD |

| | | | | | | | | | | | |
|---|---|---|---|---|---|---|---|---|---|---|---|
| | | SVM- | | | SVM- | | | SVM- | | | SVM- |
| GI | SVM-F | RFE | GI | SVM-F | RFE | GI | SVM-F | RFE | GI | SVM-F | RFE |

Separating condition 25|2.5, 1.25, 0.25

| | | | | | | | | | | | | |
|---|---|---|---|---|---|---|---|---|---|---|---|---|
| PHS2 | 59 | 359 | 522 | 31 | 1 | 7 | 59 | 228 | 194 | 31 | 1 | 6 |
| ALB | 7 | 75 | 373 | 58 | 2 | 6 | 7 | 2 | 11 | 58 | 3 | 8 |
| CAH | 6 | 75 | 372 | 252 | 4 | 22 | 6 | 1 | 5 | 252 | 2 | 11 |
| ITRA | 8 | 101 | 375 | 87 | 3 | 14 | 8 | 3 | 8 | 87 | 4 | 10 |
| Pscore | 0.90 | 1.79 | 2.22 | 1.63 | 0 | 0.69 | 0.90 | 1.37 | 1.34 | 1.63 | 0 | 0.54 |

Separating condition 25, 2.5|1.25, 0.25

| | | | | | | | | | | | | |
|---|---|---|---|---|---|---|---|---|---|---|---|---|
| PHS2 | 1017 | 351 | 432 | 2 | 1 | 1 | 1017 | 234 | 312 | 2 | 1 | 1 |
| ALB | 9 | 80 | 25 | 1 | 4 | 2 | 9 | 2 | 7 | 1 | 3 | 3 |
| CAH | 6 | 75 | 38 | 5 | 3 | 15 | 6 | 1 | 1 | 5 | 2 | 8 |
| ITRA | 30 | 88 | 32 | 3 | 2 | 7 | 30 | 3 | 6 | 3 | 4 | 7 |
| Pscore | 2.03 | 1.77 | 1.72 | 0.04 | 0 | 0.40 | 2.03 | 1.38 | 1.51 | 0.04 | 0 | 0.28 |

Separating condition 25, 2.5, 1.25|0.25

| | | | | | | | | | | | | |
|---|---|---|---|---|---|---|---|---|---|---|---|---|
| PHS2 | 2088 | 407 | 512 | 4 | 2 | 3 | 2088 | 247 | 354 | 4 | 1 | 9 |
| ALB | 892 | 91 | 83 | 2 | 3 | 7 | 892 | 2 | 10 | 2 | 3 | 8 |
| CAH | 664 | 82 | 56 | 1 | 4 | 1 | 664 | 1 | 2 | 1 | 2 | 1 |
| ITRA | 1352 | 100 | 113 | 3 | 1 | 2 | 1352 | 3 | 11 | 3 | 4 | 7 |
| Pscore | 2.70 | 1.83 | 1.88 | 0 | 0 | 0.11 | 2.72 | 1.38 | 1.58 | 0 | 0 | 0.40 |
| Tscore | 5.63 | 5.39 | 5.82 | 1.67 | 0 | 1.2 | 5.65 | 4.13 | 4.43 | 1.67 | 0 | 1.22 |

C for Min VC and C for min LOO represent the C value used during the SVM training that achieved the minimum VC Confidence and the minimum leave-one-out (LOO) error respectively. The VC-LOO and the mLOO are the LOO errors obtained for the C for Min VC and C for min LOO are used during the SVM training phase. VC-Conf-mLOO and VC-Conf-mVC represent the models VC confidence when the model was trained with the C value that produced the minimum LOO and the minimum VC confidence respectively. The VC-LOO-SV and the mLOO-SV represent the number of support vectors contained in the classification model when trained with the C for Min VC and C for Min LOO respectively.

| | No Log treatment | | | | Log treatment | | | |
|---|---|---|---|---|---|---|---|---|
| Norm. | TSC | TSC->GP | GP | UD | TSC | GP | TSC->GP | UD |

Spiking condition 25|2.5, 1.25, 0.25

| | | | | | | | | |
|---|---|---|---|---|---|---|---|---|
| C for Min VC | 2 | 2 | 2 | 2 | 2 | 2 | 2 | 2 |
| C for min LOO | 86 | 2 | 2 | 2 | 2 | 2 | 2 | 2 |
| VC-LOO | 0.27 | 0 | 0 | 0 | 0 | 0 | 0 | 0 |
| mLOO | 0 | 0 | 0 | 0 | 0 | 0 | 0 | 0 |
| VC-Conf- | 1.011 | 1.333 | 1.027 | 1.871 | 2.301 | 1.949 | 1.501 | 2.503 |
| mLOO | | | | | | | | |
| VC-Conf-mVC | 0.624 | 1.333 | 1.027 | 1.871 | 2.301 | 1.949 | 1.501 | 2.503 |
| VC-LOO-SV | 8 | 3 | 2 | 2 | 3 | 4 | 2 | 3 |
| mLOO-SV | 8 | 3 | 2 | 2 | 3 | 4 | 2 | 3 |

Spiking condition 25, 2.5|1.25, 0.25

| | | | | | | | | |
|---|---|---|---|---|---|---|---|---|
| C for Min VC | 2 | 2 | 2 | 2 | 2 | 2 | 2 | 2 |
| C for min LOO | 2 | 2 | 2 | 2 | 54 | 2 | 2 | 2 |
| VC-LOO | 0.47 | 0 | 0.27 | 0 | 0.467 | 0 | 0.20 | 0 |
| mLOO | 0.47 | 0 | 0.27 | 0 | 0.333 | 0 | 0.20 | 0 |
| VC-Conf- | 0.624 | 1.278 | 0.775 | 2.013 | 2.753 | 1.239 | 1.641 | 2.431 |
| mLOO | | | | | | | | |
| VC-Conf-mVC | 0.624 | 1.278 | 0.775 | 2.013 | >2.753 | 1.239 | 1.641 | 2.431 |
| VC-LOO-SV | 8 | 4 | 8 | 3 | 8 | 4 | 9 | 2 |
| mLOO-SV | 8 | 4 | 8 | 3 | 8 | 4 | 9 | 2 |

Spiking condition 25, 2.5, 1.25|0.25

| | | | | | | | | |
|---|---|---|---|---|---|---|---|---|
| C for Min VC | 4 | 2 | 4 | 2 | 6 | 2 | 2 | 2 |
| C for min LOO | 4 | 2 | 4 | 2 | 6 | 2 | 4 | 2 |
| VC-LOO | 0.27 | 0 | 0.27 | 0 | 0.200 | 0 | 0.267 | 0 |
| mLOO | 0.27 | 0 | 0.27 | 0 | 0.200 | 0 | 0.200 | 0 |
| VC-Conf- | 0.624 | 1.841 | 0.633 | 1.265 | 1.470 | 1.280 | 2.272 | 1.673 |
| mLOO | | | | | | | | |
| VC-Conf-mVC | 0.624 | 1.841 | 0.633 | 1.265 | 1.470 | 1.280 | 1.625 | 1.673 |
| VC-LOO-SV | 9 | 4 | 10 | 2 | 8 | 2 | 8 | 2 |
| mLOO-SV | 9 | 4 | 10 | 2 | 8 | 2 | 8 | 2 |

### Example B

No non-exhaustive feature selection methods are not guaranteed to find the optimal solution, but exhaustive feature search is impractical in problems of high dimensionality. By grouping the protein information into spectral counts, or by peaks following the MDA approach, it is also possible to perform semi-exhaustive search using advance heuristics. Such methodology can take advantage of genetic algorithms, so besides performing the information clustering, for the first time, it is also demonstrated a genetic algorithm having its fitness function based on the structure risk minimization principle. We apply this method on the same dataset acquired in Example two.

### Example B.1

### Description on the Algorithm (NaturalSVM)

A genetic algorithm based on the structure risk minimization principle from the statistical learning theory was employed to search for the spiked proteins. NaturalSVM firstly generates a population of solutions. Each individual in the population is a vector composed of zeroes and ones having its cardinality according to the number of existing features. In these vectors, zero means that the feature for the corresponding dimension will not be taken into account in a classification model. The fitness of each individual is evaluated by generating a support vector model and evaluating the VC dimension, the leave-one-out error and the number of support vectors. According to the statistical learning theory, a lower VC dimension corresponds to a less complex model, thus, the classification model is expected to generalize better. We recall that the VC dimension for the SVM classifier is a function of the separating margin among classes and the smallest radius of the hyphersphere that encompasses all input vectors.

The fitness function of the naturalSVM is given by

F=LOO+(1−1/nSV)*10+1−(1/h) (8)

where LOO is the SVM leave-one-out error, nSV is the number of support vectors and h stands for the VC dimension.

Mating among individuals of the GA population is carried according to fitness where more fit individuals have higher chances of mating. During the mating process, a crossover is performed having the offspring receive alleles from either one of its parents with equal chances.

After mating, the GA can perform mutations in the offspring. The mutation index is predefined by the user. In example, a mutation index of 2, allows the offspring to have up to two mutations, so a number of mutations between 0 and 2 is randomly chosen. The process of mating, crossover and mutation is carried out until a population of same size as the initial is created, so it can replace the previous. The user can also configure the GA to allow elitism, or a specified amount of individuals to continue in the new population.

Natural SVM can also perform what is known as island models. In this method, more than one population is created when the algorithm is initiated. After a certain amount of time specified by the user, individuals from one population are allowed to migrate to the other population according to their fitness. To take advantage of the most recent technology of multiple core processors, the GA was coded to have each population living in a different computing thread. Thus, a computer with two cores can manage two populations simultaneously without sacrificing performance. All the user predefined preferences are configured in a XML file.

To identify the spiked markers, the GA is executed various times (i.e. 10). For every execution, each time the most fit individual is substituted, his genomic information is saved in a text file. We recall that ones genomic information is defined as the vector composed of zeroes and ones, where the ones indicate that the respective feature for the corresponding dimension, or protein was taken into consideration for the classification model. The GA ceases to produce new populations after there is no increase in the fitness of the most fit individual during a user specified amount of generations. Upon execution completion, the output file will list the “evolution” of the most fit in the population we will refer to this file as the evolution file latter in the manuscript. Since the GA runs various times over the same dataset, a feature ranking can be established. This ranking is given by the ratio of how many times the most fit was substituted, and how many times a given feature remained within the genome of the most fit.

### Example B.2

### svmN Result Interpretation

To evaluate the GA, we varied various parameters. Table IV shows the GA results when configuring the 25% marker MuDPIT runs as the positive class, and the other runs as the negative class. An important result shown by Table IV is that the island model was essential in finding the correct amount of features; indeed, all runs that used Island correctly pointed out that the classification model should have four features. By observing the results in Table I, we chose the configuration of Elitism=0, Islands=180 and Mutation=2, to try and identify the spiked markers for different configurations of spiked concentrations. These results are discriminated in Table 2.

### Table IV.

The PHS2, ALB, CAH and ITRA stand for the spiked protein markers, and the number in each of the respective columns indicates the ranking of importance according to the GA methodology referred in section 2.4.6. The number underneath the Elitism column stands for how many individuals of the population were allowed to remain untouched for the following generation. The numbers contained within the island column indicate the amount of seconds required before a migration even could occur; a zero indicates that the island model was not applied. The No. Mark columns indicates how many features the GA suggested that should be taken into consideration for the classification model. The Avg. No. subst indicates how many times the most fit individual was substituted. FL stands for “feature lock”, this is a term that we defined to explain the cases when the GA can not reduce the number of features beyond a certain point, given that this amount of features is way beyond the optimal answer. The Drop column is obtained from the evolution file, and stands for the greatest difference among scores obtained by features; this is the main parameter used to estimate the amount of features in the classification model.

TABLE V
Performance of the feature selection methods

| | | | | Avg. | | | | | | | |
|---|---|---|---|---|---|---|---|---|---|---|---|
| | | | No. | No. | | | | | | | |
| Elitism | Mutation | Islands | Mark | Subst. | Runs | Drop | FL | PHS2 | ALB | CAH | ITRA |
| 0 | 1 | 0 | 113 | 754 | 10 | 0.016 | 3 | 2 | 1 | 4 | 3 |
| 0 | 1 | 180 | 4 | 590 | 10 | 0.038 | 0 | 4 | 2 | 3 | 1 |
| 0 | 2 | 0 | 5 | 493 | 10 | 0.016 | 0 | 3 | 1 | 4 | 2 |
| 0 | 2 | 180 | 4 | 394 | 10 | 0.047 | 0 | 3 | 1 | 4 | 2 |
| 0 | 3 | 180 | 4 | 317 | 10 | 0.044 | 0 | 3 | 1 | 4 | 2 |
| 1 | 1 | 0 | 52 | 869 | 10 | 0.014 | 7 | 4 | 1 | 3 | 2 |
| 1 | 1 | 180 | 4 | 691 | 10 | 0.061 | 0 | 3 | 1 | 4 | 2 |
| 1 | 2 | 0 | 7 | 614 | 10 | 0.018 | 0 | 3 | 1 | 4 | 2 |
| 1 | 2 | 180 | 4 | 477 | 10 | 0.036 | 0 | 4 | 1 | 3 | 2 |
| 1 | 3 | 0 | 5 | 480 | 10 | 0.040 | 0 | 3 | 1 | 4 | 2 |
| 1 | 3 | 180 | 6 | 491 | 10 | 0.033 | 0 | 4 | 1 | 3 | 2 |
| 1 | 3 | 180 | 4 | 391 | 20 | 0.034 | 0 | 3 | 1 | 4 | 2 |

The results below show the ranks obtained for the spiked markers (PHS2, ALB, CAH, and ITRA) for the different feature selection methodologies and for different configurations of spiked marker concentrations. For the experiments below, the GA was executed 6 times, and correctly pointed out 4 spiked markers, according to the evolution file, for all spiking concentrations. There were also no feature-locks.

| | | | |
|---|---|---|---|
| PHS2 | ALB | CAH | ITRA |

Separating condition 25 | 2.5, 1.25, 0.25

| | | | | |
|---|---|---|---|---|
| GASVM | 3 | 1 | 4 | 2 |

Separating condition 25, 2.5 | 1.25, 0.25

| | | | | |
|---|---|---|---|---|
| GASVM | 2 | 1 | 4 | 3 |

Separating condition 25, 2.5, 1.25 | 0.25

| | | | | |
|---|---|---|---|---|
| GASVM | 3 | 4 | 1 | 2 |

It was demonstrated that spectral counts can be used to classify proteomic data and pinpoint differentially expressed proteins. In our hands, the GA algorithm selected the spiked markers and indicated the correct amount of features to the model. These results suggest that this methodology could be extended to search for putative biomarkers and perform “proteomic profile classification”.

The invention described and the aspects approached must be considered as possible achievements. However, it should be highlighted that the invention isn't limited to these achievements and, those individuals skilled for the art, will realize that any particular characteristic therein introduced must be understood as something that was described to facilitate the comprehension. The limiting characteristics of the invention object are related to the claims incorporated in this report.

1. Diagnostic method based on proteomic and/or genomic patterns through the SVM analysis characterized by preferentially searching a small protenomic profile expressed by means of peaks of the spectrometry spectrum, using the mass spectrometry technique at different intervals of the spectrum.

2. Diagnostic method in accordance with claim 1, characterized by the utilization of the methodology of supporting vectors machines to classify a sample as belonging to a sick or healthy person, based on the entire or part of the proteomic profile obtained in the mass spectrometry.

3. Diagnostic method in accordance with claim 1, characterized by the fact that the data from the analysis comprised between the approximate interval of 1200 to 2200 m/z and 400 to 1200 m/z is submitted to a computing treatment in the Masslynx 3 program or similar.

4. Diagnostic method in accordance with claim 1, characterized by the fact that the data from the spectrum readings is analized using the SVM strategy, serving to obtain the separation maximum margin to positioning a hyperplane.

5. Diagnostic method in accordance with claim 4, characterized by the fact that the approach for non-separable data is done using the “slack variables” (ξ) and/or applying the kernel functions in the non-linear form (Ø).

6. Diagnostic method characterized by the fact that the data obtained in the SVM analysis are treated by means of a computer program, such program used for: (i) normalizing the spectra intensity for values between 0 and 1, having as a result of the maximum ionic current, the value 1; and, (ii) classifying and interacting with the SVMPP stage so to classify the information based on the “leave one out” approximations.

7. Diagnostic method according to claim 6 characterized by the fact that, for the peptides spectra (approximately 400-1,200 m/z), the computer program configures the spectrum data so to show a resolution of around 1 Da integrating the intermediary values.

8. Method to obtain biomarkers for diagnosis by means of a computer program, characterized by the utilization of analysis of a short extension pre-scheme “window of studies” at m/z which opening is defined by the user.

9. Diagnostic method according to claim 8 characterized by the fact that the production of data is generated by the report text file to classify all the inputs of all windows of studies and a chart where the ordinay distance for the aproximate values of 0 to 100 represent a percentage of the “healthy material” classified in each “leave one out” analysis.

10. Method in accordance with claim 9, characterized by the fact that the chart contains an upper line at the x axis representing the control patients' blood samples group classified as “healthy”, and an lower line at axis x representing the Hodgkin Disease-infected patients' blood samples group, the “non healthy” patients.

11. Method in accordance with claim 9, characterized by the fact that the chart shows maximum convergence points between two straight lines, representing the spectrum portion where most of the blood samples were “correctly” classified, further indicating the site of potential biomarkers for clinical dignosis.

12. Method in accordance with claim 9, characterized by the fact that the methodology of the computer program is further applied for other diseases diagnosis.

13. Biomarkers characterized by the fact that they are defined through the SVM analysis, after localization of the windows of interest and subsequently after the localization through the mass spectrum, so that the identification of said biomarkers may take place by means of a 2D gel or by mass spectrometry.
